(19) United States
(12) Patent Application Publication
(10) Pub. No.: US 2007/0239722 A1
(43) Pub. Date: Oct. 11, 2007

(54) Distributed user-profile data structure

(76) Inventor: Mark E. Phillips, Seattle, WA (US)

Correspondence Address: OLYMPIC PATENT WORKS PLLC, P.O. BOX 4277, SEATTLE, WA, 98104, US

(21) Appl. No.: 11/393,381

(22) Filed: Mar. 30, 2006

(51) Int. Cl. G06F 17/30

(52) U.S. Cl. 707/9

(57) ABSTRACT

Various embodiments of the present invention are directed to a distributed user-profile data structure that describes a portable-electronic-content-rendering-device user, the user's various electronic devices, the user's downloaded content, and other information that is exchanged, in initial steps of various information-exchange and transaction protocols. The distributed user-profile data structures that represent embodiments of the present invention may include a header, general user information, device information, credit card information, account information, virtual-store information, and information about one or more different types of downloadable content. Various fundamental unary and binary operations are defined on distributed user-profile data structures. The distributed user-profile data structures that represent embodiments of the present invention find use in many different dynamic, often geographically independent, electronic-device environments, including peer-to-peer interconnection environments, retailing environments, and Internet-based commerce environments.

### TECHNICAL FIELD

The present invention is related to computational data structures and electronic commerce and, in particular, to a distributed user-profile data structure that facilitates a wide variety of transactions carried out on behalf of users of portable electronic devices that access, and interact with, a variety of different remote devices, servers, and personal computers in different locations and at different times.

### BACKGROUND OF THE INVENTION

Portable, hand-held, content-rendering devices have achieved spectacular market penetration during the past several years. Such devices include Apple iPod® music players, and similar devices produced by many other consumer-electronics manufacturers, portable CD and DVD players, and a large variety of electronic devices that provide for information exchange and information display. The capacities for content storage and bandwidths for downloading content provided by these relatively recently introduced portable devices have outpaced distribution channels for retailing content to portable-device users. Moreover, current distribution channels and information-exchange methods are relatively static, and do not provide for dynamic and flexible distribution of content and information exchange that mirrors the dynamic and often geographically independent patterns of use of these portable devices. Although many of the portable devices include sufficient hardware and computational resources for a wide variety of different types of interconnections and interactions, including peer-to-peer interconnections and interactions with similar portable electronic devices, much of the potential for dynamic and spontaneous interaction with various different types of devices remains currently unexploited. The so-far untapped potential of the recently introduced portable content-rendering devices represents a relatively large, unexploited market for flexible communications applications and for flexible and dynamic marketing, retailing, and distribution of content to a very large population of potential content consumers. For this reason, manufacturers, retailers, and developers of applications for, and users of, portable electronic content-rendering devices have all recognized the need for effective tools and features to facilitate dynamic, geographically unconstrained interactions and interconnects between portable electronic content-rendering devices and other portable devices, servers, and personal computers, as well as tools and features to facilitate dynamic, geographically independent marketing, retailing, and distribution of content.

### SUMMARY OF THE INVENTION

Various embodiments of the present invention are directed to a distributed user-profile data structure that describes a portable-electronic-content-rendering-device user, the user's various electronic devices, the user's downloaded content, and other information that is exchanged, in initial steps of various information-exchange and transaction protocols. The distributed user-profile data structures that represent embodiments of the present invention may include a header, general user information, device information, credit card information, account information, virtual-store information, and information about one or more different types of downloadable content. Portable electronic content-rendering devices and other electronic computing systems may support applications that carry out various fundamental unary and binary operations on distributed user-profile data structures, including addition, deletion, and update of information, merging, synchronization, and merge/synchronization operations, exchange of distributed user-profile data structures with remote devices, and filtering or projection operations. The distributed user-profile data structures that represent embodiments of the present invention find use in many different dynamic, often geographically independent, electronic-device environments, including peer-to-peer interconnection environments, retailing environments, and Internet-based commerce environments.

### BRIEF DESCRIPTION OF THE DRAWINGS

FIG. 1 shows an exemplary kiosk for automated retailing and distribution of content.

FIG. 2 shows a representative portable electronic content-rendering device.

FIG. 3 illustrates the types of remote devices to which a portable electronic content-rendering device may interconnect for downloading content, exchanging information, uploading content, and for carrying out any of a wide variety of different types of transactions.

FIGS. 4A-G illustrate various embodiments of the distributed user-profile data structure to which the present invention is directed.

FIG. 5 illustrates a set of fundamental operations exemplary of the operations carried out on distributed-user-profile-data-structure instances of the present invention.

FIGS. 6A-C illustrate exemplary distributed-user-profile-data-structure one-way or two-way exchanges that may occur in the initial stages of a wide variety of protocol-based interconnections between a portable electronic content-rendering device and another device.

FIG. 7 illustrates a number of uses for the distributed user-profile data structure that represent various embodiments of the present invention.

### DETAILED DESCRIPTION OF THE INVENTION

Various embodiments of the present invention are directed to a distributed, user-profile data structure that facilitates dynamic, geographically independent interconnections between portable electronic content-rendering devices and remote devices in computer systems, and that facilitates a wide variety of dynamic, geographically independent transactions. In the following discussion, the commercial and electronic environments in which the distributed user-profile data structures are employed are first described, followed by a description of representative distributed user-profile data structures, a description of fundamental operations typically carried out on distributed user-profile data structures, a description of one-way and two-way exchanges of distributed user-profile data structures between devices, and a description of a number of the many types of interconnections, transactions, and other operations facilitated and made possible by the distributed user-profile data structures.

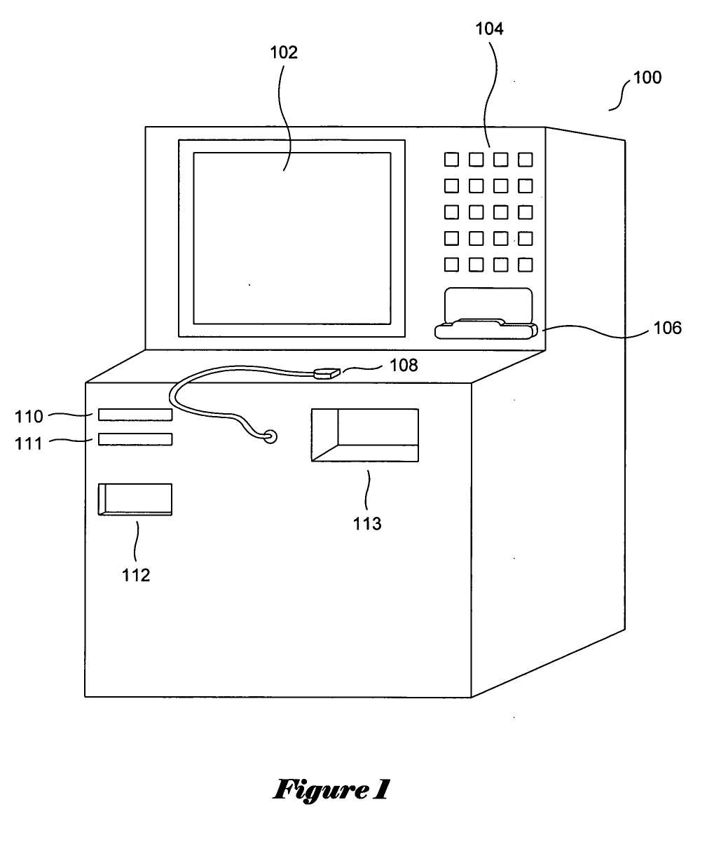

FIG. 1 shows an exemplary kiosk for automated retailing and distribution of content that represents one system embodiment of the present invention. As shown in FIG. 1, the kiosk 100 includes: (1) a display screen 102 for displaying user interfaces, content, and other information; (2) one or more various user-input means 104, such as a key pad, touch screen, or other input means; (3) a card reader 106; (4) an electronic port 108, such as a USB connector; (5) compact-disk trays 110-111; and (6) various additional ports and/or receptacles for various types of portable devices 112-113, including wireless connection features, such as RF transceivers. A wide variety of different kiosk implementations are possible. For example, the user input means may be created with the display screen 102 when the display screen has touch-screen capabilities. As another example, a kiosk may feature a much wider variety, and greater number, of ports and other electronic connections to allow users to connect many different portable devices of different types. Internally, the kiosk includes at least one processor, memory, an operating system running on the one or more processors, one or more mass storage devices, typically one or more communications links that link the kiosk with a central content storage and distribution system, and a kiosk control program. Kiosks provide a convenient, low-overhead means for retailers to sell and distribute content to users of portable electronic content-rendering devices.

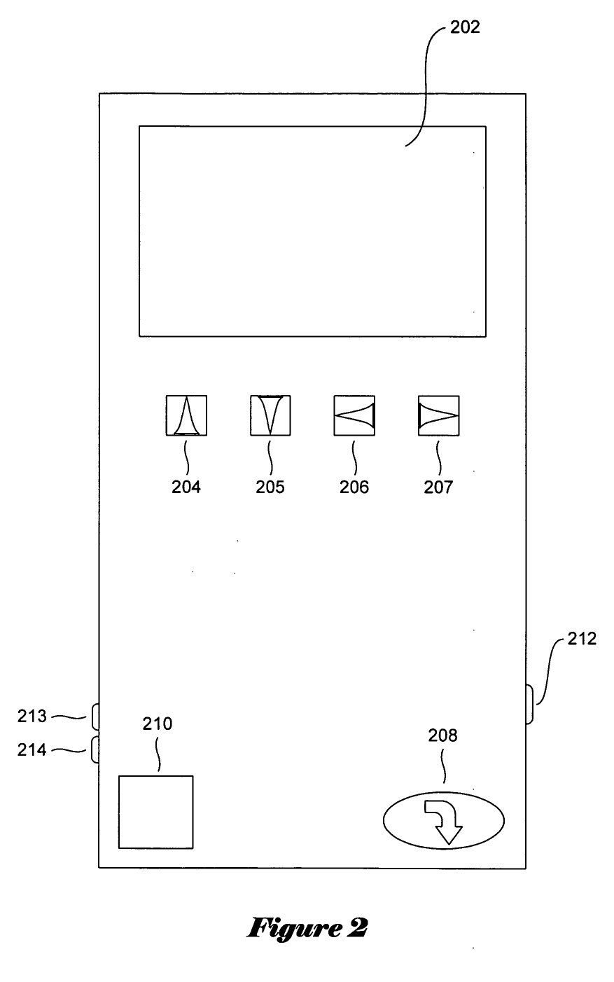

FIG. 2 shows a representative portable electronic content-rendering device. Such devices typically include a display area 202 for displaying textual and graphical information, including lists of content, photographs and video, account activity information, information about transactions, virtual-store catalogs, and other information useful to portable-device users. Devices include navigational buttons, such as navigational buttons 204-207 shown for the device in FIG. 2, and other buttons or input features, such as buttons that allow options to be highlighted and selected. In addition to a display screen 202, such devices typically include one or more output ports 212 for outputting audio signals to headphones or speakers, and one or more input ports 213 and 214 to allow the device to be interconnected with a personal computer, retailing kiosk, modem, or other such electronic devices. In many cases, portable electronic content-rendering devices additionally include internal antennas to allow the devices to interconnect with remote devices via radio-frequency signals, and may additionally include sensors and light-transmission features for optical interconnections with remote devices. Portable electronic content-rendering devices, such as the device shown in FIG. 2, generally include large amounts of internal data storage, typically including electronic memory and magnetic-disk-based mass-storage devices.

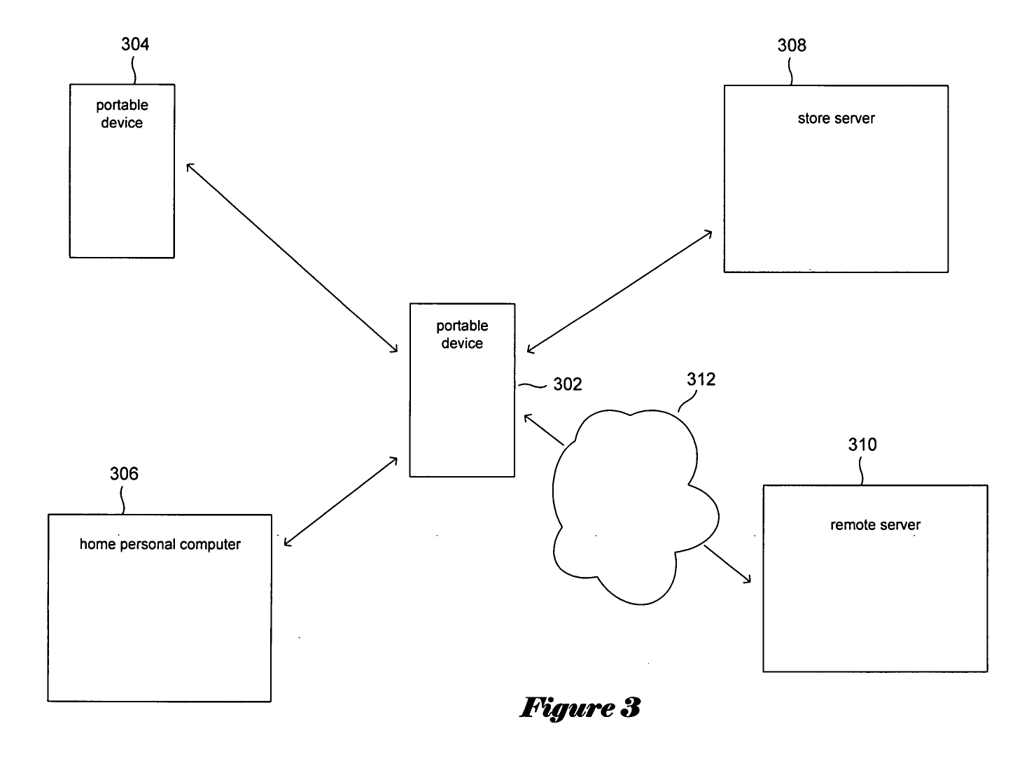

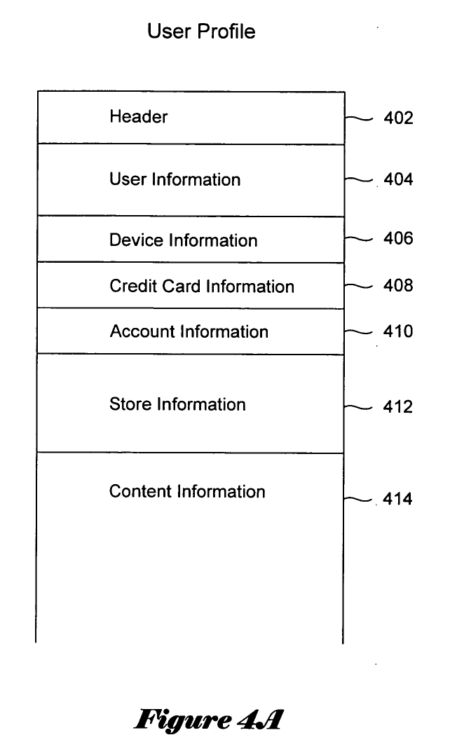

FIG. 3 illustrates the types of remote devices to which a portable electronic content-rendering device may interconnect for downloading content, exchanging information, uploading content, and for carrying out any of a wide variety of different types of transactions. As shown in FIG. 3, a portable electronic content-rendering device 302 may interconnect with: (1) another portable electronic content-rendering device 304 in a peer-to-peer fashion via a wireless connection, an optical connection, or a cable-mediated electronic connection; (2) a personal computer 306 via wireless, optical, or cable connection; (3) a retail server or retailing kiosk 308 via a wireless, optical, or cable connection; and (4) a remote server or other computing system 310 via any of a wide variety of different types of network and internet connections 312, including connections to the remote server or computer system through a local personal computer, modem, or other electronic device.

The varied possible interconnections between a portable electronic content-rendering device and other devices provide enormous opportunities for different types of information exchanges, many different types of transactions, and a wide variety of different types of content acquisition and distribution. A user of a portable electronic content-rendering device may wish to, for example, scan through and purchase content made available from a retailing kiosk within a retail setting while shopping for other items or services. In addition, the user may wish to scan through and purchase content from any of a number of different virtual stores, accessible to the user through wireless connections, local-area network connections, and the Internet. Alternatively, a user may wish to interconnect with the portable electronic content-rendering device of another user, in a peer-to-peer fashion, in order to exchange content, browse the other user's content, preferences, playlists, and other information, or to exchange and share additional types of information that may be stored within the two portable electronic content-rendering devices. However, these activities generally require that the user identify himself or herself, enter sufficient information to interact or initiate desired transactions and information exchange, enter account information and credit card information in order to initiate purchase transactions, and enter identification information or other information concerning licenses for receiving content. In general, portable electronic content-rendering devices do not provide full alphanumeric keyboards, as provided on personal computers, to facilitate data entry. Thus, information entry may be relatively time consuming on portable electronic content-rendering devices. Moreover, users of portable electronic content-rendering devices normally use the devices in dynamic and geographically diverse situations, often under time constraints and in environments with multiple distractions, such as in social settings and retail environments. Users often forego information exchanges and transactions that involve entering more than a few keystrokes of information in such settings. Therefore, in order to take advantage of the large distribution, retailing, and information exchange opportunities provided by portable electronic content-rendering devices, a means for automatic transmission and exchange of pertinent user information is needed so that information exchanges and transactions can be executed by a user with minimum data input and with maximum time efficiency.

Various embodiments of the present invention are directed to a distributed user-profile data structure that facilitates exchange of user information between a portable electronic content-rendering device and any of a variety of remote devices, including other portable electronic content-rendering devices, servers, personal computers, and centralized computing systems. Local copies of the distributed user-profile data structure may reside on electronic devices owned by a particular user, as well as on remote servers, retailing kiosks, personal computers, and portable electronic content-rendering devices of other users. Thus, the distributed user-profile data structure is distributed both over the devices owned and controlled by the user described by the distributed user-profile data structure as well as distributed over a variety of remote devices which the user may access through any of the user's devices. The various local copies, or instances, of the distributed user-profile data structure may contain identical, commonly shared information as well as information unique to only one or a subset of the instances of the distributed user-profile data structure. However, fundamental operations associated with the distributed user-profile data structures of the present invention allow for independent devices to manage multiple instances of the distributed user-profile data structure in order to store and extract information needed for the various types of information exchange and transactions facilitated by the distributed user-profile data structure.

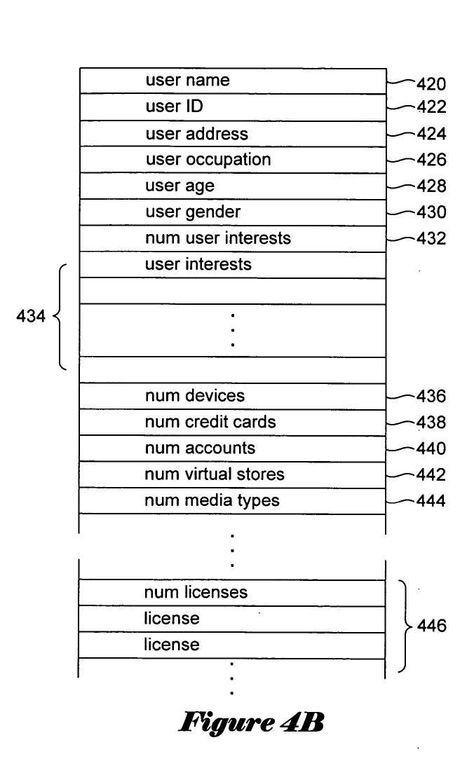

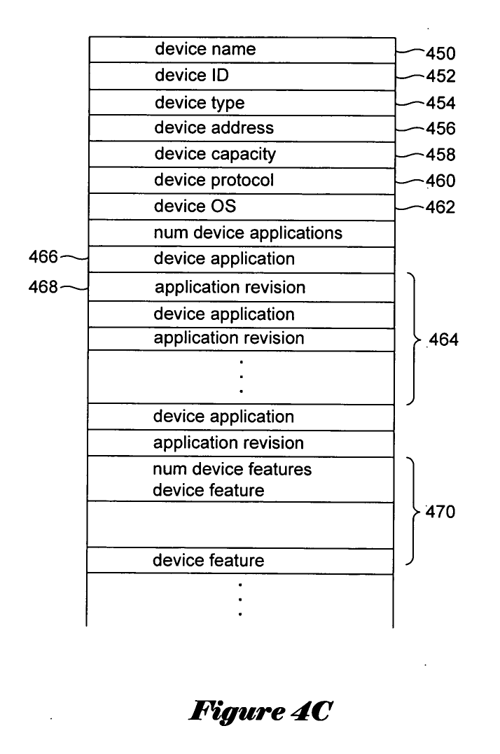

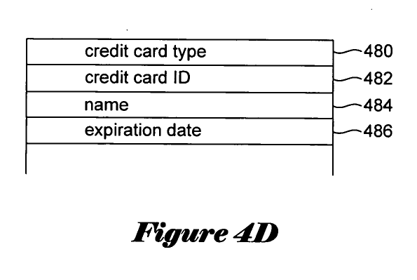

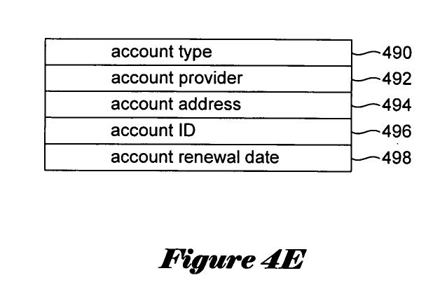

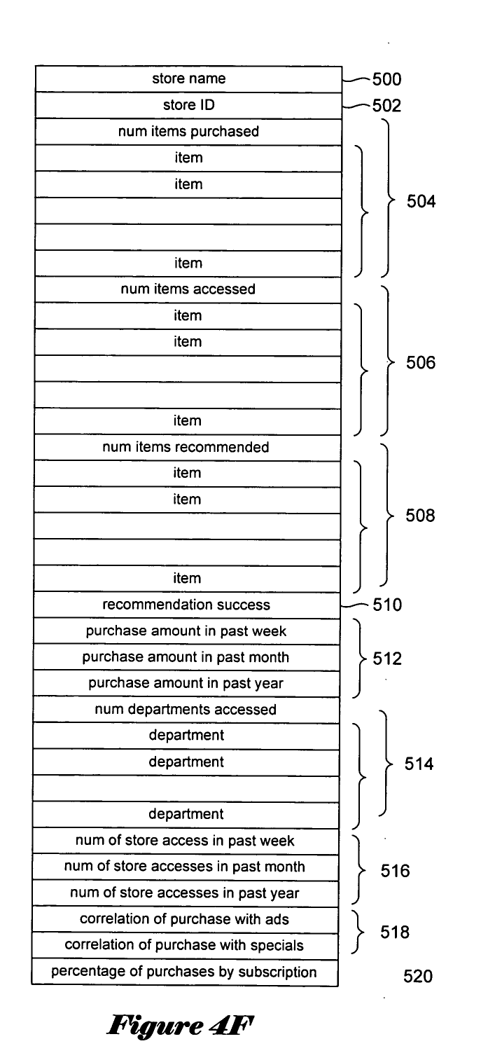

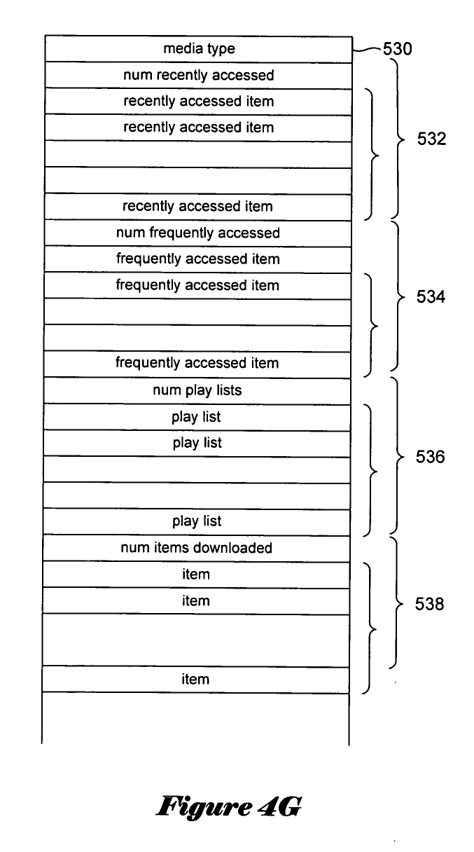

FIGS. 4A-G illustrate various embodiments of the distributed user-profile data structure to which the present invention is directed. FIG. 4A shows a high-level abstraction of the distributed user-profile data structure. As shown in FIG. 4A, the distributed user-profile data structure includes a header 402, general user information 404, device information 406, credit card information 408, account information 410, virtual-store information 410, and content information 414. Each of the broad types of information shown in the distributed user-profile in FIG. 4A consists of many different lower-level fields and lists. In FIGS. 4A-G, fields, lists, and other data structures are shown abstractly. The sizes of the fields, lengths of the lists, and other such characteristics of the fields and lists shown in the figures are not representative of the actual sizes, in bytes, or of the encoding and ordering of the fields, lists, and other internal information-storing entities within the distributed user-profile data structure. This abstract approach is motivated both by the desire for simple and clear explanation as well as by the fact that particular embodiments of the distributed user-profile data structure may have quite different, and unique, codings and organizations, depending on the underlying architecture of the devices that store them, on the operating systems and control programs resident within the devices, and on the particular protocols and standards in which the depicted distributed user-profile data structures are used. Furthermore, particular types of information, such as account numbers or user identification information, may be encoded in many different ways, including numerically, alphanumerically, in compressed form, and with other types of variations and different characteristics.

The header information in the distributed user-profile data structure may include an indication of the overall length of the particular instance of the data structure as well as a revision number, indication of protocols with which the instance of a distributed user-profile data structure is compatible, and other such high-level information applicable to the data structure as a whole. The distributed user-profile data structure may be largely self-describing, in which case an extensive header is not needed, or, by contrast, may require a relatively large amount of header information in order to define the header to remote devices and applications. In certain embodiments, the distributed user-profile data structure may be defined as part of a communications standard, in which case only a very minimal header, or no header, may be required.

FIG. 4B shows exemplary contents of the general-user-information portion of the distributed user-profile data structure (404 in FIG. 4A). General user information may include a user name 420, a user ID 422, a user's address 424, an indications of the user's occupation 426, the user's age 428, and the user's gender 430, a list of indications of the user's interests, including, in certain implementations, a field indicating the number of interests in the list 432 followed by the list of interests 434, numerical indications of the number of devices 436, credit cards 438, user accounts 440, virtual stores 442, and media types 444 described in the following portions of the distributed user-profile data structure (i.e., 406, 408, 410, 412, and 414 in FIG. 4A), and a list of licenses and/or digital certificates owned by the user 446. The general-user-information portion of the distributed user-profile data structure may include many additional types of fields and lists, and particular embodiments of the distributed user-profile data structure may include only a subset of the fields and lists described with reference to FIG. 4B.

FIG. 4C illustrates an exemplary device description that may be included in the device information portion (406 in FIG. 4A) of the distributed user-profile data structure that represents an embodiment of the present invention. The device description may include a device name 450, a numerical device identification number 452, a device type 454, a device address, such as an LP address 456, an indication of the device's capacity for content storage 458, an indication of the type of protocol or protocols used by the device 460, an indication of the type of OS or other control program resident within the device 462, a list of the different types of application programs resident within the device 464, each application represented by a device application field 466 and an application revision number 468, and a list of particular features supported by the device 470. Device features may include various types of content-rendering features, such as display screens, audio output generators, input features, and other such features. Again, as with the general user information description discussed above with reference to FIG. 4B, particular embodiments of the distributed user-profile data structure may include additional types of information for describing devices, and others may include less information than that shown in FIG. 4C.

FIG. 4D shows an exemplary credit card descriptor that may be included in the credit card-information portion (408 in FIG. 4A) of the distributed user-profile data structure that represents an embodiment of the present invention. A credit card descriptor may include a credit card type 480, a numerical credit card ID, or account number 482, a name 484, and an expiration date 486. Additional types of information may also be included.

FIG. 4E shows an exemplary account descriptor that may be included in the account information portion (410 in FIG. 4A) of the distributed user-profile data structure that represents one embodiment of the present invention. An account descriptor may include an account-type field 490, indication of the account provider, such as an indication of a particular retailer or retail location, an account address, such as the mailing address or internet address of the account provider, an account ID 496, and an account renewal date 498. Particular embodiments of the present invention may include a greater number of information fields, or less information fields, than shown in FIG. 4E.

FIG. 4F shows an exemplary virtual-store descriptor that may be contained in the virtual-store-information portion (412 in FIG. 4A) of a distributed user-profile data structure that represents one embodiment of the present invention. The description of a virtual store may include the store's name 500, a numerical ID for this store 502, a list of recently purchased items purchased by the user from the store 504, a list of items browsed or accessed by the user from the virtual store 506, a list of items recently recommended to the user by the virtual store 508, indications of the success rate of recommendations by the virtual store to the user 510, indications of the dollar amount of purchases by the user from the virtual store 512, indications of the departments of the virtual store accessed recently by the user 514, indications of the number of times the user has accessed the virtual store during recent periods of time, indications of correlations of purchases by the user with ads provided to the user and specials offered to the user by the virtual store 518, and an indication of the percentage of purchases by the user on a subscription basis 520. Items in the various lists 504, 506, and 508 may be numerical or alphanumerical item identifiers specific to a particular virtual store or may be standardized product number codes. The information contained in a virtual-store descriptor can be used for tailoring recommendations, advertising, specials, and other virtual-store offerings and activities to particular users, on a per-user basis or on a per-user-group basis. This information may also prove useful, when compiled for a large number of users, in management and organization of the virtual store, and may even be useful in managing virtual-store inventories, staffing, development efforts, and other aspects of a virtual-store. As with the other descriptors and data structures within the distributed user-profile data structure, particular embodiments of the present invention may include additional fields or may include a subset of the fields shown in FIG. 4F.

FIG. 4G shows an exemplary media descriptor that may be included in the content-information portion (414 in FIG. 4A) of the distributed user-profile data structure that represents one embodiment of the present invention. A media-type descriptor may include fields that designate the type of media 530, a list of the most recently accessed items of the media type 532, a list of the most frequently accessed items of the media type 534, a list of various playlists created by the user or imported by the user which include the type of media described by the media descriptor 536, and a list of downloaded or purchased items of the media type 538. The information stored in a media-type descriptor may serve as a catalog of content items of the media type accessed and purchased by a user, and may provide detailed information to allow remote devices to suggest and furnish content of the media type to the user in various transactions. As with the other descriptors and data structures discussed above, particular embodiments of the present invention may employ media-type descriptors with additional fields or with only a subset of the fields shown in FIG. 4G.

Various embodiments of the distributed user-profile data structure to which the present invention is directed typically include timestamps associated with each field and list item, to indicate the date and time when the field or list item values were entered. In addition, various embodiments of the distributed user-profile data structure to which the present invention typically include metadata that serve to describe the organization, fields, lists, and other data structures included within the distributed user-profile data structure, allowing instances of a particular distributed user-profile data structure to have different numbers and types of fields, lists, and other internal data-structure entities.

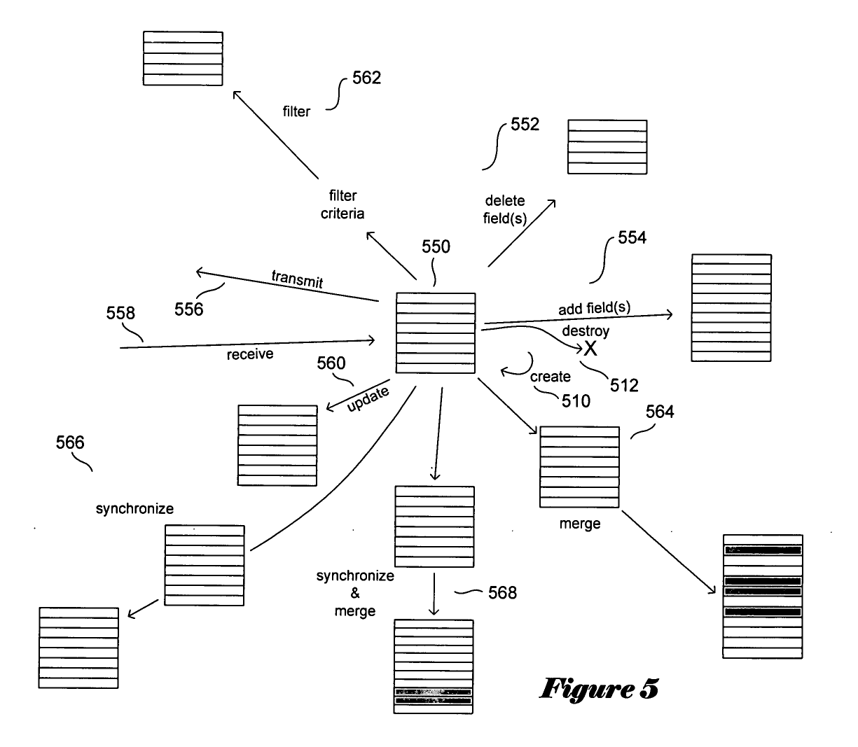

Various device-resident, kiosk-resident, and computer-system-resident applications may store and manipulate local instances of the distributed user-profile data structure, as discussed above. In order to do so, these applications generally implement a set of fundamental unary and binary operations on distributed-user-profile-data-structure instances. FIG. 5 illustrates a set of fundamental operations exemplary of the operations carried out on distributed-user-profile-data-structure instances of the present invention. As shown in FIG. 5, a distributed-user-profile-data-structure instance 550 may serve as the operand in unary operations that: (1) delete fields from the distributed user-profile data structure 552; (2) add fields to the distributed user-profile data structure 554 associated with new timestamps; (3) transmit distributed user-profile data structures to, and receive distributed user-profile data structures from, remote devices 556 and 558; (4) update the contents of one or more fields or descriptors within the distributed user-profile data structure 560 and the associated timestamps; and (5) filter, or project, a distributed user-profile data structure 562 in order to mask particular fields, descriptors, and lists that the application does not want to make available to a remote entity when the distributed user-profile data structure is transmitted to the remote entity or to routines within the application. Binary operations include: (1) merging a first distributed-user-profile-data-structure instance with a second distributed-user-profile-data-structure instance 564; (2) synchronizing a first distributed-user-profile-data-structure instance with a second distributed-user-profile-data-structure instance 566; and (3) synchronizing and merging a first distributed-user-profile-data-structure instance with a second distributed-user-profile-data-structure instance 568. The merge operation may coalesce two distributed-user-profile-data-structure implementations together by including a single copy of commonly shared fields with identical values from the operand data-structure instances in resulting data structure, and adding to the resulting data structure fields present in only one of the two operand instances. For commonly shared fields, the merge may be directed to extracting the value from one of the two operand instances, or may default to extracting the value from one of the two instances. A synchronization operation uses time stamps associated with the fields in two distributed-user-profile-data-structure instances in order to produce a resultant data structure that includes commonly shared fields of the two instances with values having the most recent time stamps. A synchronize and merge binary operation merges two instances of distributed user-profile data structures, choosing values for commonly shared fields based on time stamps associated with those fields. Finally, fundamental operations include create and destroy operations 570 and 572. The set of fundamental operations shown in FIG. 5, or equivalent sets of fundamental operations, provide the underlying functionality needed by applications that access and manage distributed user-profile data structures in order to carry out all of the various types of interconnections, exchanges of information, and transactions between portable electronic content-rendering devices and other devices.

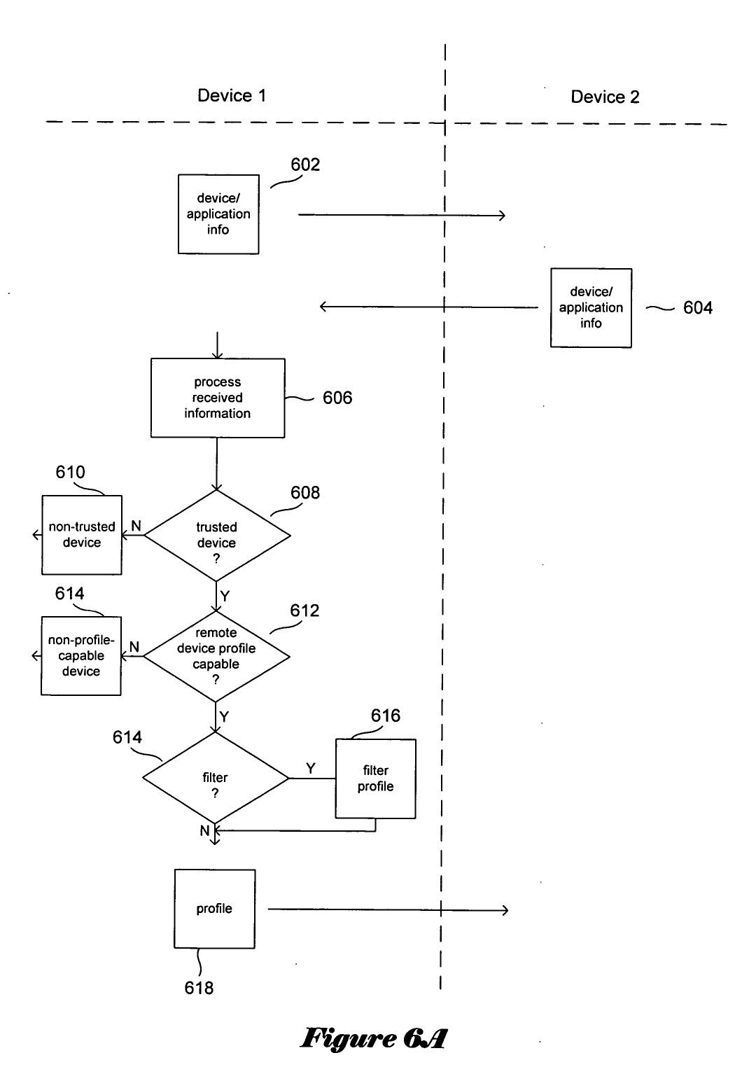

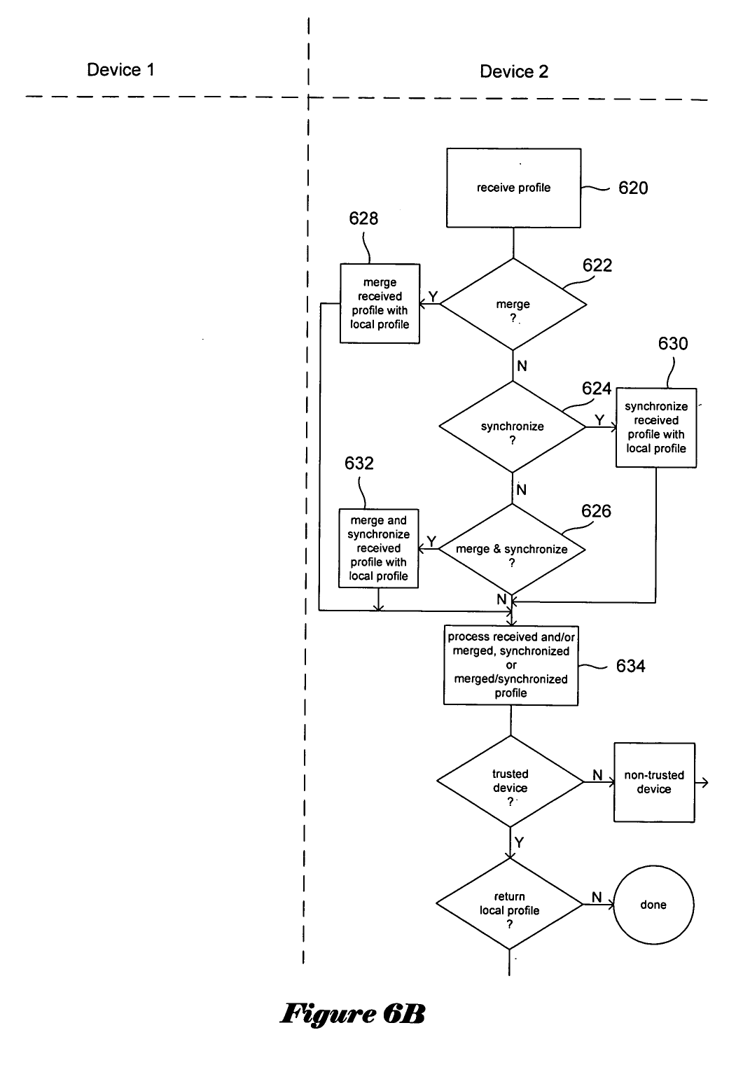

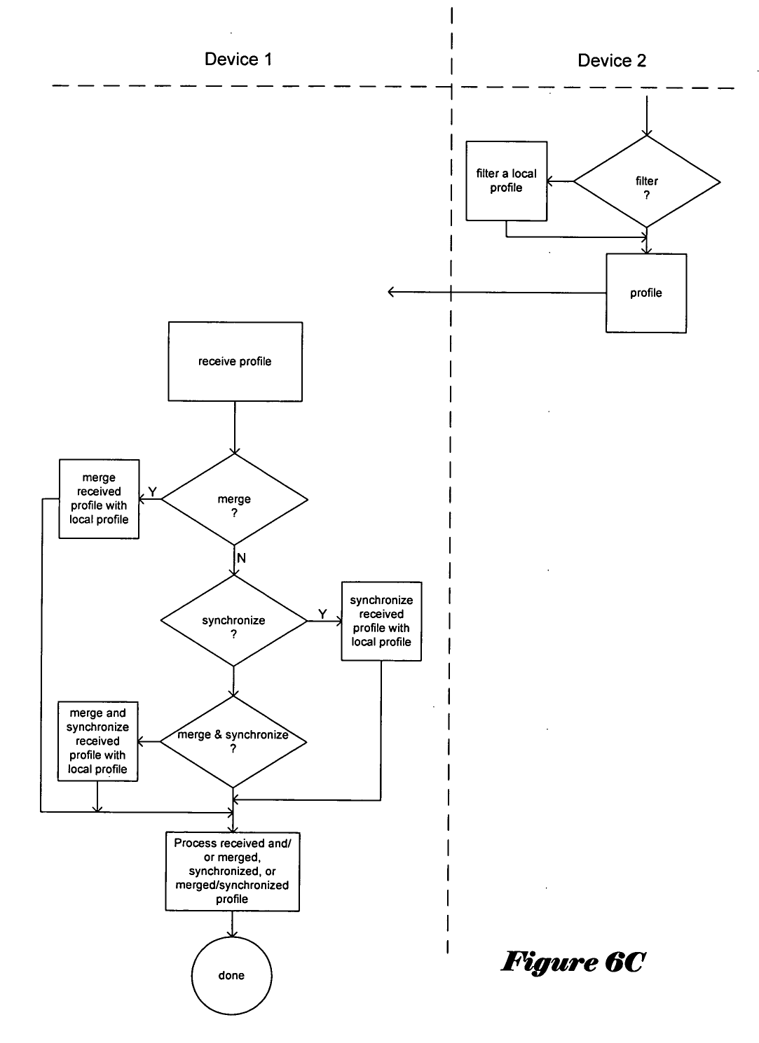

In general, the distributed user-profile data structures that represent embodiments of the present invention are typically exchanged in the initial stages of interconnection between a portable electronic content-rendering device and a remote device, according to various interconnection, information-exchange, and transaction protocols. FIGS. 6A-C illustrate exemplary distributed-user-profile-data-structure one-way or two-way exchanges that may occur in the initial stages of a wide variety of protocol-based interconnections between a portable electronic content-rendering device and another device. FIGS. 6A-C use a hybrid control-flow diagram and message-passing illustration convention to illustrate this exemplary exchange. In the initial stages of interconnection, the first device, activities and steps for which are shown in the left-hand column of FIG. 6A-C, sends preliminary, minimal device and application information 602 to the second device, activities and steps for which are shown in the right-hand side of FIG. 6A-C. The second device responds by sending minimal device and application information 604 back to the first device. On receiving that information, the first device processes the received information in step 606. If the first device determines that the second device is not a trusted device, in step 608, then a profile exchange may not occur, and a non-profile-based protocol, not further discussed in this document, may be chosen for subsequent activities 610. Otherwise, if the second device is determined by the first device to not be capable of receiving and manipulating a distributed user-profile data structure, as determined in step 612, then a non-profile-based protocol may be elected for subsequent steps 614, also not further discussed in this document. Otherwise, the first device determines whether or not to filter its local instance of its distributed user-profile data structure, in step 614. If filtering is needed, then the first device employs a filtering operation (562 in FIG. 5) to mask various selected fields from the distributed user-profile data structure instance before sending a copy of that instance to the second device, in step 616. Finally, a local instance of the distributed user-profile data structure is sent by the first device 618 to the second device. Upon receiving the instance of the distributed user-profile data structure by the second device, in step 620 of FIG. 6B, the second device determines, in steps 622, 624, and 626, whether the received distributed user-profile data-structure instance should be merged, synchronized, or merged and synchronized with a local instance of a distributed user-profile data structure stored on the second device and, if so, carries out the merge, synchronization, or merge and synchronization operations in steps 628, 630, and 632, respectively. The second device processes the received and/or merged, synchronized, or merged and synchronized profile according to the needs and requirements of the second device and of the connection, information exchange, or transaction that is being carried out, in step 634. In the remaining steps shown in FIGS. 6B and 6C, the second device decides whether or not to send a local distributed-user-profile-data-structure instance back to the first device, and the first device, upon receiving the profile, determines whether or not to merge, synchronize, or merge and synchronize the profile with a local copy.

When a user connects the user's portable electronic content-rendering device with a kiosk or retailing computer system, the kiosk or retailing computer system generally synchronizes and merges a received distributed user-profile data structure with a local instance of the distributed-user-profile data structure in order to update and maintain a centrally stored instance of the distributed user-profile data structure. The kiosk or retailing computer system may or may not return an instance of the distributed user-profile data structure to the portable electronic content-rendering device, depending on the nature of the information exchanged or transaction being carried out. By contrast, in peer-to-peer interconnections between portable electronic content-rendering devices, merge, synchronization, or merge and synchronization operations may be less frequently used, and may be carried out later, during the course of a transaction or information exchange, to produce a temporary result data structure useful in directing latter stages of the transaction or information exchange. FIG. 6A-C serve to illustrate a variety of different initial exchanges of distributed-user-profile-data-structure instances for a variety of different types of connections, information exchanges, and transactions, rather than particular protocols or exchanges.

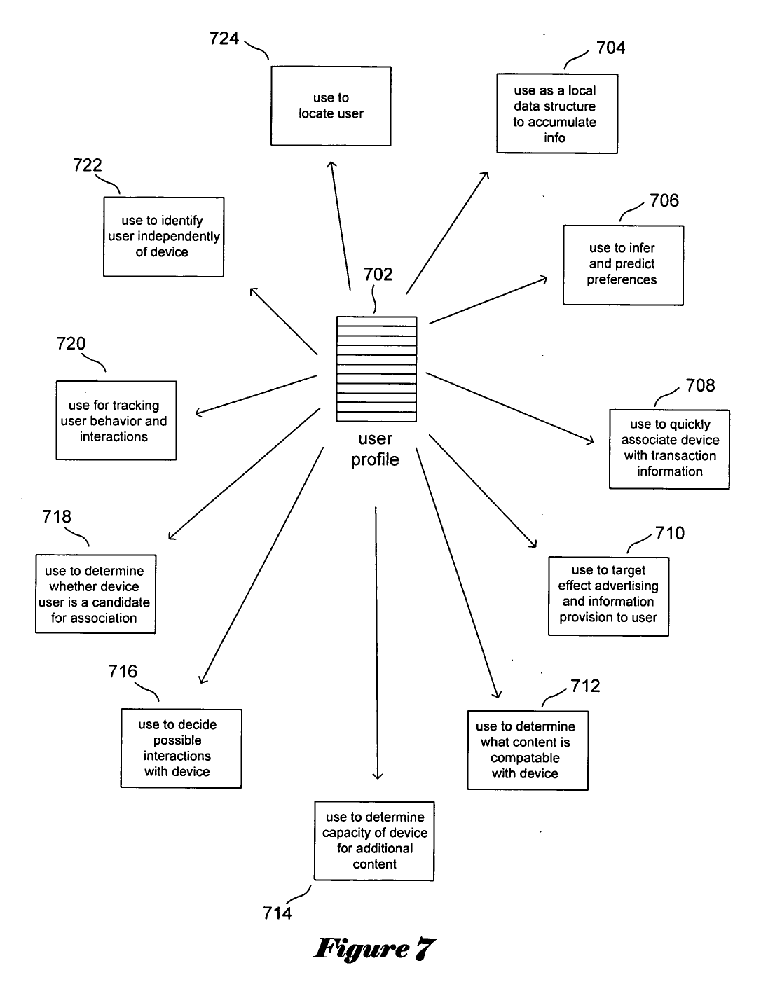

FIG. 7 illustrates a number of uses for the distributed user-profile data structure that represent various embodiments of the present invention. A distributed user-profile data structure 702 may be used: (1) as a local data structure for accumulating information 704 on both a portable device as well as a kiosk or retailing computer system; (2) for inferring and predicting user preferences interests by other portable electronic content-rendering devices, kiosks, and centralized retailing computer systems 706; (3) for quickly associating a connecting device with transaction information needed to complete one of various types of transactions 708; (4) for targeting effective advertising, information provision, and offers and specials to users by kiosks and retailing computer systems 710; (5) for determining what content is compatible with a connecting portable electronic content-rendering device by a kiosk or retailing computer system 712; (6) for determining the capacity of a connecting portable electronic content-rendering device for receiving additional content by a kiosk or retailing-system computer 714; (7) for deciding if possible information exchanges and transactions can be carried out with a connecting portable electronic content-rendering device 716; (8) for determining whether a detected portable content-rendering device candidate for various types of associations, such as peer-to-peer associations with other portable electronic content-rendering devices or customer or browser associations with kiosks and retailing computer systems; (9) for tracking user behavior and interactions with a virtual store by a virtual store; (10) for identifying a user independently of the particular portable electronic content-rendering device or home computer system which the user is currently using 722; and (11) for locating a particular user by attempting to contact the user through various of the user's portable electronic content-rendering devices, home computers, and other devices, addresses for which are stored in the distributed user-profile data structure. The uses for the distributed user-profile data structures of the present invention shown in FIG. 7 represent merely a small subset of the many possible uses for the distributed user-profile data structure in a wide array of networks, associations, retailing environments, information-exchange environments, and other environments based on portable electronic content-rendering devices.

Although the present invention has been described in terms of particular embodiments, it is not intended that the invention be limited to these embodiments. Modifications within the spirit of the invention will be apparent to those skilled in the art. For example, various distributed user-profile data structures may contain different fields, lists, and other data structures than those shown in FIGS. 4A-G. Various embodiments of the distributed user-profile data structure may include a variety of different types of lower-level data structures, metadata describing the lower-level data structures, and types of associated data in addition to timestamps needed for synchronization and synchronization and merge operations. For example, distributed user-profile data structures may contain cryptographic keys and/or digital signatures for verifying authenticity of data contained in the distributed user-profile data structures. Certain applications may consider one instance of a distributed user-profile data structure to be a master data structure, with remaining instances of the distributed user-profile data structure considered to have temporary, copied, or newly input data derived from, or eventually to be transferred to, the master distributed user-profile data structure. In other embodiments, the distributed user-profile data structure may be fully distributed, with all instances bearing peer relationships among themselves.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A distributed user-profile data structure encoded in at least one computer readable medium and transmitted from one device or another or exchanged by two devices during initial stages of an information-exchange or transaction, the distributed user-profile data structure comprising:
fields and internal data structures that together compose a header;
fields and internal data structures that together compose a general-user-information portion;
fields and internal data structures that together compose a device-information portion;
fields and internal data structures that together compose a virtual-store information;
fields and internal data structures that together compose data-content information.

2. The distributed user-profile data structure of claim 1 wherein the header includes:
an indication of an overall length of the distributed user-profile data structure.

3. The distributed user-profile data structure of claim 2 wherein the header further includes:
a revision number; and
an indication of protocols with which the instance of a distributed user-profile data structure is compatible.

4. The distributed user-profile data structure of claim 1 wherein metadata that describes organization and sizes of remaining portions of the distributed user-profile data structure.

5. The distributed user-profile data structure of claim 1 wherein the general-user-information includes:
a user identification number.

6. The distributed user-profile data structure of claim 5 wherein the general-user-information further includes:
a user name;
a user address;
a user occupation;
a user age;
a user gender; and
a list of indications of user interests.

7. The distributed user-profile data structure of claim 1 wherein the general-user-information further includes:
numerical indications of a number descriptors stored within additional portions of the of distributed user-profile data structure.

8. The distributed user-profile data structure of claim 1 wherein the device-information portion includes:
one or more device descriptors that each includes:
a numerical device identification number.

9. The distributed user-profile data structure of claim 1 wherein a device descriptor further includes:
a device name;
a numerical device identification number;
a device type;
a device address;
an indication of the device's capacity for content storage;
an indication of the type of protocol or protocols used by the device;
an indication of a type of OS or other control program resident within the device;
a list of particular features supported by the device.

10. The distributed user-profile data structure of claim 1 wherein the virtual-store-information portion includes:
a numerical ID for a virtual store.

11. The distributed user-profile data structure of claim 10 wherein the virtual-store-information portion further includes:
a virtual-store name;
a list of recently purchased items purchased from the virtual store;
a list of virtual-store items recently browsed or accessed; and
a list of items recently recommended by the virtual store;

12. The distributed user-profile data structure of claim 10 wherein the virtual-store-information portion further includes:
indications of a success rate of recommendations by the virtual store;
indications of an amount of purchases from the virtual store; and
indications of correlations of purchases with ads provided, and specials offered, by the virtual store.

13. The distributed user-profile data structure of claim 10 wherein the virtual-store-information portion includes:
indications of departments of the virtual store recently accessed;
indications of a number of times the virtual store has been accessed during recent periods of time; and
an indication of the percentage of purchases on a subscription basis.

14. The distributed user-profile data structure of claim 1 wherein the data-content information portion includes:
one or more media descriptors, each media descriptor including:
one or more fields that designate the type of media.

15. The distributed user-profile data structure of claim 1 wherein the media descriptor further includes:
a list of the most recently accessed items of the media type;
a list of most frequently accessed items of the media type;
a list of play lists;
a list of downloaded or purchased items of the media type indicated by the one or more fields that designate the type of media.

16. The distributed user-profile data structure of claim 1 further including:
fields and internal data structures that together compose a credit-card-information portion; and
fields and internal data structures that together compose an account-information portion.

17. The distributed user-profile data structure of claim 1 further including timestamps associated with values stored in data fields and other internal data structures.

18. The distributed user-profile data structure of claim 1 further including cryptographic keys associated with values stored in data fields and other internal data structures.

19. The distributed user-profile data structure of claim 1 further including digital signatures associated with values stored in data fields and other internal data structures.

20. An instance of the distributed user-profile data structure of claim 1 stored in a portable electronic content-rendering device.

21. One or more additional instances of the distributed user-profile data structure of claim 20 stored in one or more of:
a content-retailing kiosk;
a personal computer;
a server; and
another content-rendering device.
